(19) United States
(12) Patent Application Publication
(10) Pub. No.: US 2007/0226349 A1
(43) Pub. Date: Sep. 27, 2007

(54) Mobile terminal, data processor, and data transmitting and receiving system

(75) Inventor: Kyoichi Nakaguma, Yokohama (JP)

Correspondence Address: MCDERMOTT WILL & EMERY LLP, 600 13TH STREET, N.W., WASHINGTON, DC, 20005-3096, US

(73) Assignee: Hitachi Ltd.

(21) Appl. No.: 11/481,968

(22) Filed: Jul. 7, 2006

(30) Foreign Application Priority Data
Mar. 22, 2006 (JP) 2006-077979

(51) Int. Cl. G06F 15/16

(52) U.S. Cl. 709/227

(57) ABSTRACT

A mobile terminal acquires related information with respect to a user, retains the acquired related information, transmits the retained related information, detects a position of the mobile terminal, transmits a transmission request signal that requires the transmission of the digest when the detected position satisfies a predetermined condition, and receives the digest based on the related information. The data processor stores the information, receives the related information with respect to a user, generates the digest that summarizes the information stored upon receipt of the related information based thereon, retains the generated digest, receives the transmission request signal that requires the transmission of the digest, and transmits the retained digest upon receipt of the transmission request signal.

This application claims the benefit of priority of Japanese Application No. 2006-077979 filed Mar. 22, 2006, the disclosure of which also is entirely incorporated herein by reference.

### TECHNICAL FIELD

The invention relates to a mobile terminal, a data processor, and a data transmitting and receiving system.

### BACKGROUND

Recently a personal digital assistance that allows down loading of various contents including moving images and music, replay and browsing of such contents has been increasingly widespread.

Japanese Patent Laid-open Publication No. 2003-50810 discloses a portable telephone that allows a user to download the digest from a digest supply system that generates the digest by extracting the scene from indexed multi-media contents based on a predetermined keyword. The portable telephone includes a preference data transmitter that transmits the predetermined keyword to the digest supply system as a user's preference information, a digest acquiring unit that downloads the digest generated based on the preference information, and a digest replay unit that replays the digest.

### SUMMARY

It may be the case that a user is likely to use the mobile terminal to browse the contents in his/her spare time like commuting time. With the process for generating the digest by the server in response to receipt of a user's request, the time for a user to browse the digest is limited.

With the process for transmitting and receiving the digest at a predetermined time, it is unlikely that a user desires to browse the received digest or a user browses them regularly, leading to waste of the memory and unnecessary use of the communication infrastructure.

It is an object of the invention to provide a mobile terminal that allows a user to view the digest easily, a data processor that transmits the digest, and the data transmitting and receiving system.

In an embodiment according to the invention, a mobile terminal acquires related information with respect to a user, retains the related information that has been acquired, transmits the retained related information, detects a position of the mobile terminal, transmits a transmission request signal that requires a transmission of the digest if the detected position satisfies a predetermined condition, and receives the digest based on the related information.

In the embodiment according to the invention, a data processor stores the information data, receives related information with respect to a user, generates the digest that summarizes the stored information data upon receipt of the related information based thereon, retains the generated digest, receives a transmission request signal that requires a transmission of the digest, and transmits the retained digest upon receipt of the transmission request signal.

### BRIEF DESCRIPTION OF THE DRAWINGS

FIG. 1 is a block diagram of a mobile terminal 1 and a server 2.

FIG. 2 is a view showing a rating data retention unit 104 and rating data 300.

FIG. 3 is a view showing a display for acquiring user's rating by the operation acquisition unit 100.

FIG. 4 is a flowchart of a control routine for generating the rating data 300 upon acquisition of a user's rating.

FIG. 5 is a flowchart of control routines executed in the system.

FIG. 6 is a flowchart of control routines executed in the system.

### DETAILED DESCRIPTION

### Best Mode for Carrying Out the Invention

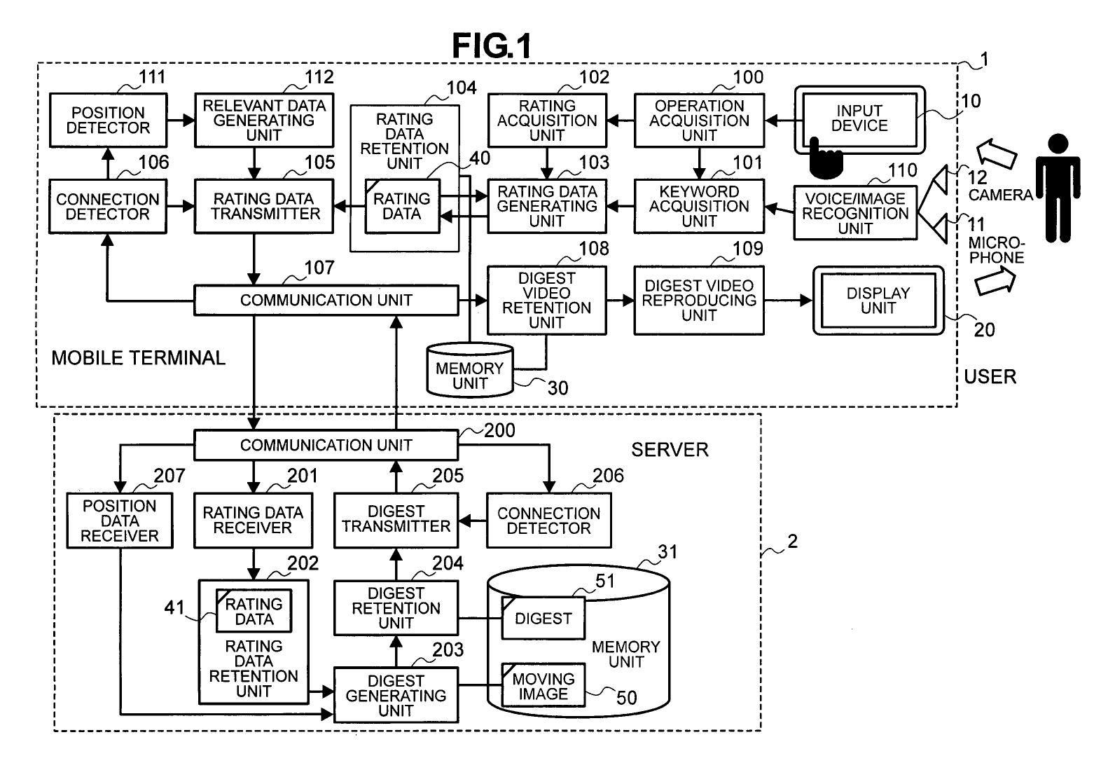

FIG. 1 is a block diagram showing a structure of a data transmitting and receiving system. The data transmitting and receiving system includes a mobile terminal 1, a server 2, and communication channels connected via radio, wired, or media. In the following description, the term “contents” refers to the information including music, moving image, voice, and text data, and the “digest” refers to the information generated by summarizing the contents.

The mobile terminal 1 is an information terminal that can be carried with a user, for example, a mobile telephone, PDA and the like. The mobile terminal 1 includes an input device 10 that acquires a user's operation, a microphone 11 that acquires a user's voice, a camera 12 that acquires a user's motion, and a memory unit 30 that stores data. The input device 10 is formed of the device that acquires characters or operations input by a user, for example, the keyboard, touch panel and the like. The memory unit 30 is a data storage unit that stores a large capacity of data, for example, a hard disc, a flash memory and the like.

The mobile terminal 1 is provided with a voice/image recognition unit 110 that recognizes the data received from the camera 12 or the microphone 11, an operation acquisition unit 100 that acquires a user's operation through the input device 10, a keyword acquisition unit 101 that acquires a keyword 301 based on the data from the operation acquisition unit 100 or the voice/image recognition unit 110, a rating acquisition unit 102 that acquires a rated value 302 with respect to the keyword based on the data received from the operation acquisition unit 100, a rating data generation unit 103 that generates rating information 40 based on the keyword 301 and the rated value 302, a rating data retention unit 104 that retains the rating information 40 in the memory unit 30, a communication unit 107 that communicates with the server 2, a connection detector 106 that detects the connection of the communication unit 107, a position detector 111 that detects a position of the mobile terminal 1, and a relevant data generating unit 112 that generates data relevant to the mobile terminal 1, a rating data transmitter 105 that transmits the rating data 40 to the server 2 via the communication unit 107, and a digest video retention unit 108 that retains the digest 51 acquired from the server 2 via the communication unit 107 in the memory unit 30, and a digest video replay unit 109 that replays the digest 51.

The voice/image recognition unit 110 formed of a control unit, for example, CPU, or a memory exhibits the function of extracting the keyword from the voice or the image. The feature quantity of the voice that has been input is made in contrast with the recognition dictionary stored in the memory unit so as to recognize the voice. The feature quantity of the image that has been input is brought into matching with the template image stored in the memory unit so as to analyze the image. The control unit for executing the character recognition may be employed, or the character recognition may be made under the control with software. The voice/image recognition unit 110 is activated so as to input the rating data 40.

The position detector 111 that acquires the position of the mobile terminal may be a radio IC that communicates with the radio IC reader provided at a predetermined place to detect the position of the mobile terminal. Alternatively, GPS may be employed as the position detector, and the device that acquires the current position by measuring the radio field intensity from the radio base station through the three-point measurement may also be employed. However, the position detector is not limited to the one that calculates the physical coordinates of the mobile terminal 1, but may be formed into an arbitrary form so long as the movement of the mobile terminal into or from the predetermined area may be detected.

As a specific example of the position detector 111, a ticket gate passage detection unit using the radio IC, for example, the mobile Suica™ may be used. The position detector 111 detects the passage of the mobile terminal 1 through the ticket gate by executing the communication with the reading unit such as the IC reader installed in the gate or the ticket gate of the railway, bus, and airport. The position detector 111 acquires the information that the mobile terminal 1 has passed through the ticket gate, and serves to transmit the information with respect to the passage to the server 2 because the time for which a user on board is suitable for browsing the digest.

In the case where the radio IC reader is installed for admitting a person to enter and leave home or the office in place of the use of key, the entering and leaving home or the office may be detected through the radio IC installed in the mobile terminal 1. When a user leaves his/her work at the office, that is, the leaving is detected, the mobile terminal starts communication with the server 2 so as to transmit and receive the digest.

The relevant data generating unit 112 is formed as the device or the program that generates the information relating to the mobile terminal 1, which includes the control unit such as the CPU, memory, and programs to be stored therein. The relevant data may contain data that relate to the position and the time. Specifically, the data that relates to the position of the mobile terminal 1 includes the information whether a user enters the ticket gate, exits from the ticket gate, a user leaves home or the office. The data that relates to the time includes the information, for example, the time period for which a user is on board the train. The time period for which a user is on board may be derived from the difference between the time at which a user enters the ticket gate, which has been acquired by the position detector 111 and the time at which a user exits from the gate. The data with respect to the block specified in the commuter pass may be input by a user or derived from the mobile terminal 1 such that the time at which a user rides on the train may be calculated based on the information of the block specified by the commuter pass. The digest to be replayed at a timing conforming to the passage of time is generated. This makes it possible to allow a user to browse the digest conforming to the time at which a user is on board the train.

If the time at which a user rides on the train is stored on a daily basis in addition to the information with respect to the passage of time, the information about the time schedule of a user's boarding may be calculated. The server 2 stores such boarding time schedule in the memory unit 30 so as to calculate the time at which generation of the digest starts.

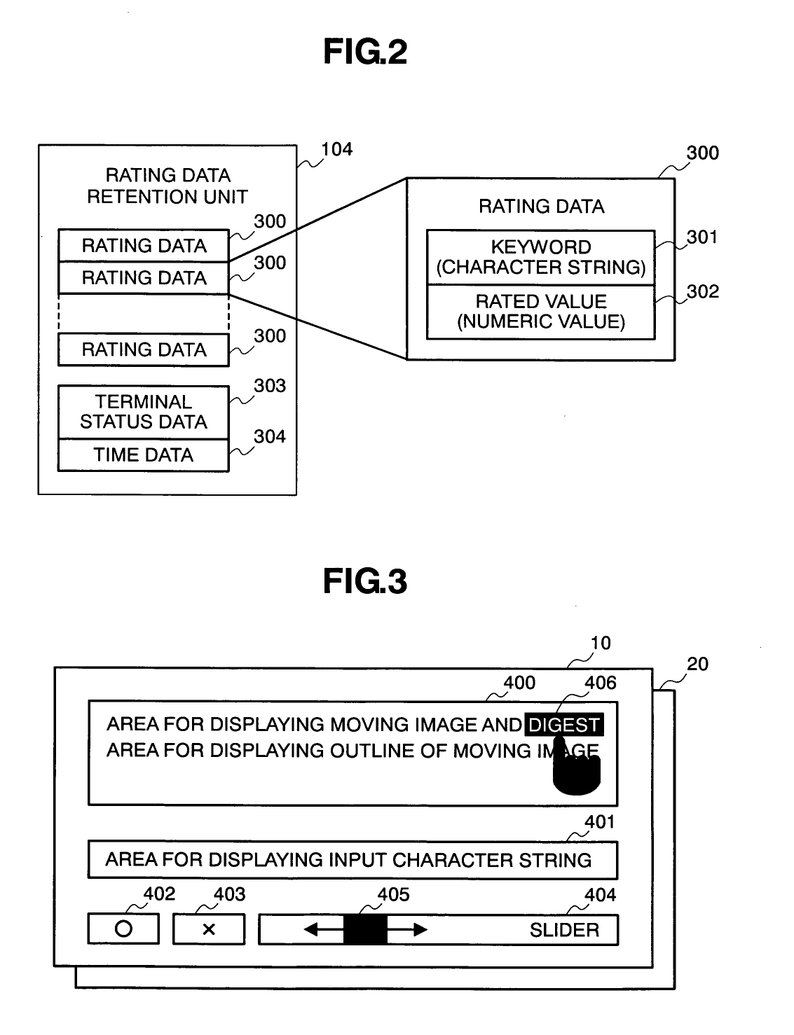

The rating data retention unit 104 will be described referring to FIG. 2.

The rating data retention unit 104 is a memory unit or a database unit that stores the data of the mobile terminal 1, for example, the memory, hard disc drive and the like, which is structured to allow the mobile terminal 1 to use freely. The rating data retention unit 104 retains one or more rating data 300 (corresponding to the one with the reference numeral 40 in FIG. 1), the terminal status information 303, and time data 304. The rating data 300 is formed of a keyword acquired through the operation acquisition unit 100, and a rated value 302 that uniquely represents a user's rating with respect to the keyword 301. The rating data 300 is used as the one indicating a user's preference.

The keyword 301 includes character string separated by word as the text information. The display of the operation acquisition unit 100 for acquiring the keyword 301 will be described later referring to FIG. 3.

The terminal status data 303 is the numeric value that uniquely represents the position of the mobile terminal 1, for example, whether the mobile terminal 1 is positioned outside the ticket gate, it has already passed through the gate, it is in the gate or the like, and the state of the mobile terminal 1 as to which function is used. The positional status may be acquired by the position detector 111. The aforementioned information is acquired at timing when the position detector 111 detects the entrance of the mobile terminal 1 into the ticket gate. The time information 304 represents the passage of time taken from the previous entrance of the gate to the subsequent exit from the ticket gate. The time information 304 is acquired by the relevant data generating unit 112. The time information 304 is acquired after the mobile terminal 1 exits from the gate.

The server 2 is a data processing system formed as the information electric appliance including a TV, a hard disc drive recorder, a personal computer, a set top box, a terminal unit including an automatic ticket gate in station, or a server employed for an ASP. The server 2 as the data processing unit may be connected to the mobile terminal 1 via a radio or a wired communication unit 200. The memory unit 31 is a data storage device capable of storing a large capacity of data information, which may be formed as the hard disc or the flash memory. The memory unit 31 preliminarily stores a moving image 50 which may be contents of the TV program that has been recorded, or contents supplied by other media such as DVD and CD. The contents may be formed only of voice data. Each of the contents is assigned with supplementary information and meta-information indicating the category information, feature of the scene and the like. The category represents the classified information which identifies the recorded program into specific category, for example, sports, news, program for kids or adults, and the like. The category information refers to the information indicating the category of the contents.

The server 2 includes a communication unit 200 that communicates with the mobile terminal 1, a rating data receiver 201 that receives rating data using the communication unit 200, a rating data retention unit 202 that retains the received rating data, a digest generating unit 203 that generates the digest based on the moving image stored in the memory unit 31 and rating data, a digest retention unit 204 that retains the generated digest, a digest transmitter 205 that transmits the retained digest using the communication unit 200, and a connection detector 206 that detects a connection of the line. The aforementioned units are formed by arbitrarily combining the control unit such as CPU, the data storage unit such as the memory, the program stored in the data storage unit, the communication device and the like.

The digest generating unit 203 generates the digest of the moving image 50 based on the supplementary information assigned thereto and the rating data 41 retained in the rating data retention unit 202. Assuming that the moving image 50 is assigned with the supplementary information and the meta-information indicating features by the scene, and the information that matches the keyword 301 containing the rated value 302 larger than a predetermined value is contained in the supplementary information and the meta-information assigned to the moving image 50, the moving image in the appropriate area may be captured so as to be generated as the digest. The digest may be generated by the arbitrary process so long as the scene that contains the keyword 301 with the rated value 302 at the higher level is captured.

The display of the operation acquisition unit 100 will be described referring to FIG. 3.

The operation acquisition unit 100 acquires the keyword 301 and the rated value 302 from the input device 10. The character string may be directly input through the keyboard, or the character string which has been recognized from the touch panel may be input. FIG. 3 shows an example of acquisition of the rated value 302 in the operation acquisition unit 100.

The operation acquisition unit 100 may be provided in the mobile terminal 1 such that a sensor device like a touch panel capable of acquiring coordinates serving as the input device 10 is provided above the display unit 20, for example, the liquid crystal display, cathode-ray tube display, plasma display and the like. The display unit 20 includes a character area 400 that displays the moving image 50, the digest 51, the description with respect to the moving image 50, an input area 401 that displays the data input through the keyboard, a selected area 406 that specifies the keyword 301 by selecting a part of the character string in the character area 400, a positive rating button 402 and a negative rating button 403 for setting the rated value 302 with respect to the selected area 406, and a rating bar 405 that shows the slider 404 for setting the rate of the rated value 302 with respect to the maximum value thereof set to 100, and the current rated value 302.

The character area 400 displays the character string input through the keyboard or the touch panel, the moving image 50, or the outline of the digest 51. The specific word displayed in the character area 400 is pointed through the touch panel so as to be captured as the keyword 301 shown as the selected area 406 in FIG. 3.

The input area 401 temporarily displays the character string input through the keyboard and the touch panel.

The positive rating button 402 is used for indicating the positive rating with respect to the currently selected keyword 301. When a user presses the positive rating button 402 with respect to the keyword 406, the positive value is added to the rated value 302.

The negative rating button 403 is used for indicating the negative rating with respect to the currently selected keyword 301. When a user presses the negative rating button 403 with respect to the keyword 406, the negative value is added to the rated value 302.

The slider 404 serves as a graphical interface that changes the rated value 302 visually using the rating bar 405. If a user shifts the rating bar 405 rightward, the positive natural number is added to the rated value 302. Meanwhile, if a user shifts the rating bar 405 leftward, the negative natural number is added to the rated value 302. The rated value 302 may be set to a maximum value by shifting the rating bar 405 to the right end. Likewise, the rated value 302 maybe set to a minimum value by shifting the rating bar 405 to the left end.

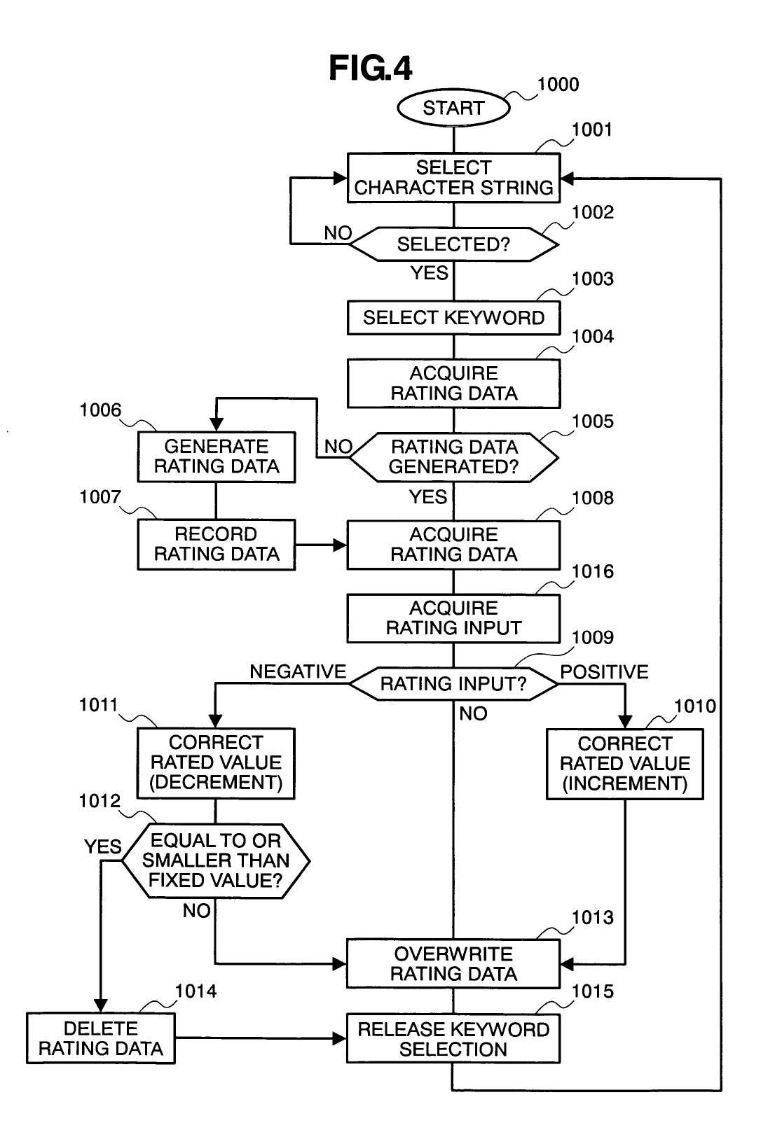

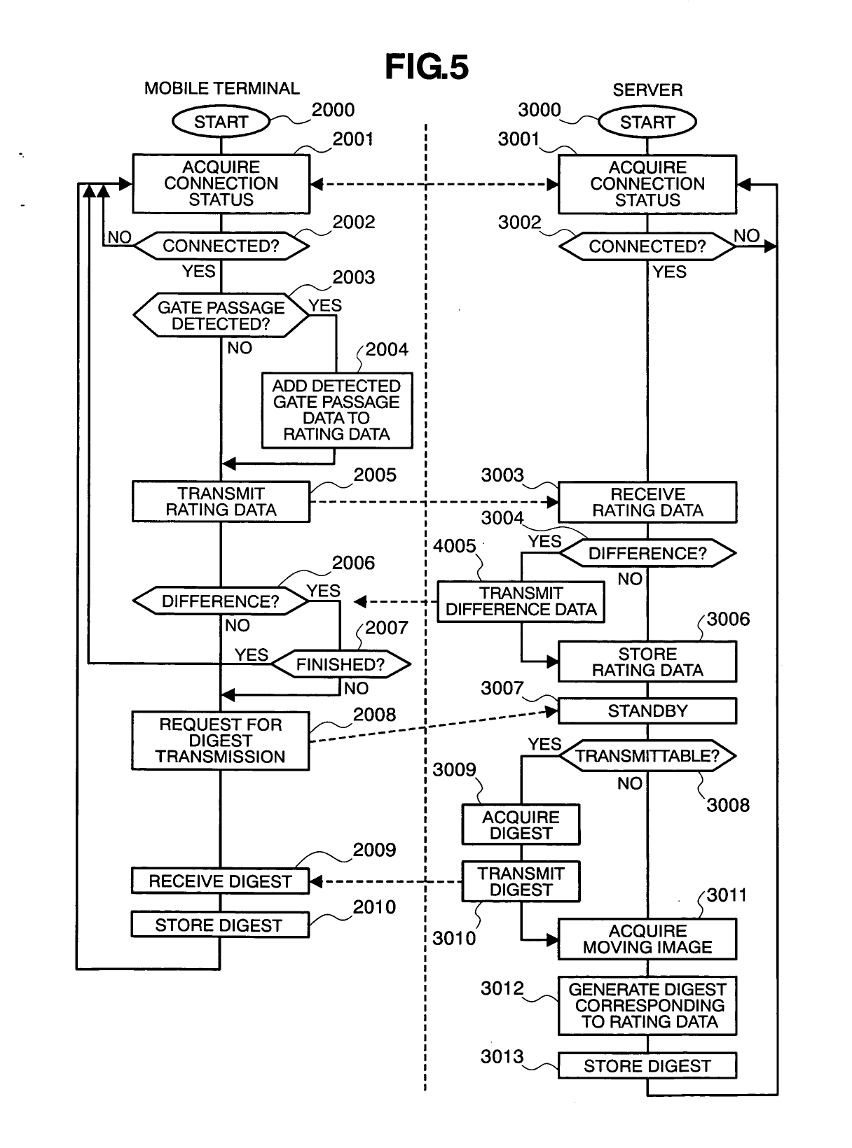

The operation of the rating data generating unit 103 that generates the rating data 300 with respect to the keyword 301 for changing the rated value in response to the operation of a user will be described referring to the flowchart of FIG. 4.

The selected area 406 of the character string displayed in the display area 400 is designated based on the position information through the touch panel, and the designated character string is acquired by the rating data generating unit 103 in step 1001. Then in step 1002, if the character string has not been selected yet, the process returns to step 1001 where the character string is continuously displayed. If the character string has been selected, the process proceeds to step 1003 where the character string is divided by the word such that the keyword 301 is selected in step 1003. The keyword may be acquired by the voice/image recognition unit 110.

The rating data generating unit 103 searches the rating data 300 retained in the rating data retention unit 104 to locate the rating data 300 containing the keyword that is the same as the keyword 301 in step 1004. If the rating data containing the same keyword 301 are not located, the process proceeds to step 1006 where the rating data generating unit 103 generates new rating data based on the default rated value 302 and the keyword 301, and then further proceeds to step 1007 where the generated rating data are registered in the memory unit 30 controlled by the rating data retention unit 104. The process then proceeds to step 1008. In step 1008, if the same keyword 301 is located among the rating data 300, the rating data generating unit 103 acquires the searched rating data 300.

The rating data generating unit 103 acquires the rating data with respect to the keyword 301 through a user's operation acquired by the operation acquisition unit 100 in step 1016. Specifically, this may be established by a user's operation of the positive rating button 402, the negative rating button 403 or the rating bar 405. If a user does not operate the positive rating button 402, the negative rating button 403, or the rating bar 405, the rating data have no change. Accordingly the process proceeds to step 1013. If the positive rating button 402 is pressed or the rating bar 405 is shifted to the positive direction, the rating data generating unit 103 adds the appropriate positive value to the rated value 302 of the rating data 300. The rated value may be increased through a user's operation in step 1010. If the negative rating button 403 is pressed or the rating bar 405 is shifted to the negative direction, the rating data generating unit 103 subtracts the appropriate positive value from the rated value 302 of the rating data 300, and the rated value may be decreased through a user's operation in step 1011.

If the rated value 302 is equal to or smaller than a predetermined value in step 1012, the rating data generating unit 103 determines that the rating data 300 are worthless, and deletes the rating data 300 from the database in the rating data retention unit 104 in step 1014, and the process proceeds to step 1015. If the rated value 302 is not equal to or smaller than the predetermined value, the rating data generating unit 103 overwrites the rating data over the one registered in the rating data retention unit 104 in step 1013.

The currently selected area 406 is released in step 1015, and the process returns to step 101. The aforementioned process allows the server 2 to generate the rating data 300 with respect to the keyword 301 such that the rating data generating unit 103 is operated for controlling the rated value 302 in response to a user's operation.

The flowchart shown in FIG. 5 shows an exemplary explanation with respect to:
the mechanism for transmitting the rating data 300 accumulated in the mobile terminal 1 to the server 2 at timing when the connection to the server 2 is established, or the mobile terminal 1 passes the ticket gate;
the mechanism for generating the digest 51 while the line is not connected; and
the mechanism for transmitting the digest 51 to the mobile terminal 1, having the data length corresponding to the length of time within the passage of time from entrance of the mobile terminal into the ticket gate to its exit at the timing when the line is connected.

First in step 2001, the mobile terminal 1 acquires the status of the communication line. It is then determined whether the line connection to the server is established in step 2002. The line is connected to the server 2 at timing when a user requires the server 2 to transmit the digest 51 through operation of the mobile terminal 1, or at timing when the position detector 111 detects the passage of the mobile terminal 1 through the ticket gate.

If the line connection to the server 2 is not established, the process returns to step 2001 where the process is kept standby until the line connection is established. Then in step 2003, it is determined whether the position detected by the position detector 111 indicates the passage of the mobile terminal 1 through the ticket gate. If it is determined that the mobile terminal 1 has passed the ticket gate, the terminal status data 303 are added to the rating data 300. The time information 304, if any, may be added to the rating data in step 2004. The process then proceeds to step 2005.

While the server 2 acquires the communication line status in step 3001, and it is determined whether the connection to the mobile terminal 1 has been established in step 3002. If the line communication to the mobile terminal 1 is not established, the process returns to step 3001 where the process is kept standby until the line connection is established.

If the line connection is detected in step 2002, the rating data 300 retained in the rating data retention unit 104 are transmitted to the server 2 in step 2005.

The server 2 then receives the rating data 300 transmitted from the mobile terminal 1 in step 3003. In step 3004, it is determined whether there is a difference between the previously transmitted rating data 300 from the mobile terminal 1 and the current rating data 300. If there is the difference, the difference information indicating the presence of the difference is transmitted to the mobile terminal 1 instep 4005. The rating data 300 are then stored in the memory unit 31 of the server 2 in step 3006. If it is determined that there is no difference in step 3004, the server 2 does not transmit the difference information, and stores the rating data 300 in the memory unit 31 of the server 2 in step 3006.

The “difference” used herein refers to the one between the keyword contained in the rating data 300 transmitted from the mobile terminal 1 to the server 2 and the rated value 302, and the supplementary information added to the digest stored in the memory unit 31 of the server 2, which will be transmitted in the subsequent step.

The mobile terminal 1 receives the difference information from the server 2, and it is determined with respect to the presence or absence of the difference in step 2006. In response to the notification with respect to the presence of the difference, a user is notified of such difference through the display unit 20. A user is further required to determine whether the process is stopped. If a user determines to stop the process, the process returns to step 2001 where the mobile terminal 1 is kept standby until the line connection is established. If a user determines not to stop the process in step 2007, the process proceeds to step 2008 where the mobile terminal 1 transmits the digest transmission request signal that requires transmission of the digest 51 currently retained in the memory unit 31.

The server 2 is kept standby until the transmission request is received in step 3007. Upon receipt of the transmission request, it is determined whether the digest 51 can be transmitted in step 3008. If the transmission cannot be performed, it may be determined that the digest 51 is not generated. If it is determined that the transmission can be performed, the server 2 acquires the digest 51 retained in the memory unit 31 in step 3009, transmits the digest 51 to the mobile terminal 1 in step 3010, and the process proceeds to step 3011.

In step 2009, the mobile terminal 1 receives the digest 51 transmitted in step 3010. The digest 51 is stored in the memory unit 30 in step 2010, and the process proceeds to step 2001 where the process is kept standby until the line connection is established.

In step 3011, the moving image 50 retained in the memory unit 31 is acquired, and in step 3012, the digest 51 is generated based on the rating data 300 and the moving image 50.

In step 3012, the time for replaying the digest is adjusted conforming to the terminal status data 303 of the rating data 300 and the passage time indicated by the time data 304.

The server 2 may be designed to generate a plurality of digests each having a different length of replay time based on the same contents. The server 2 is allowed to generate three digests each having the length of replay time of 5 minutes, 10 minutes, and 20 minutes, respectively. The digest to be transmitted to the mobile terminal 1 may be determined by correlating the terminal status data 303 to be transmitted upon the next line connection with the time for replaying the digest. In the case where it is confirmed that a user has entered the ticket gate based on the terminal status data 303, the digest 51 having the length of replay time that matches the time data 304 may be transmitted and received. In the case where the supplementary information representing the category of the moving image is assigned to the digest 51, the server 2 is allowed to store the table that correlates the digest information added to the moving image 50 to the received terminal status data 303 in the memory unit 31. The digest may be generated by the category such that the digest to be transmitted to the mobile terminal 1 is changed by the terminal status data 303. This allows a user to receive the digest having the length of replay time and the category conforming to the terminal status.

The digest 51 generated in step 3012 is transmitted to the mobile terminal 1 upon subsequent establishment of the line connection.

The digest 51 is generated by the server 2 or such generation starts before establishment of the next line connection. The time for generating the digest does not take long from the line connection to the transmitting and receiving of the digest 51. This may allow a user to browse the digest further efficiently during the spare time. In the case where the line is connected in response to a user's request, and the line is connected in response to the entrance of the ticket gate, the time for receiving the digest may be reduced.

In the case where the server 2 is the information electric appliance provided at home as a home server like a hard disk recorder, the contents browsing history of a user at home may be stored in the memory unit 31 so as not to be contained in the digest 51 combined to be transmitted to the mobile terminal 1. This makes it possible to reduce the chance for a user to view the contents that have been already seen at home. Accordingly, the efficient browse of the contents may be realized, resulting in improved convenience.

The digest 51 generated in step 3012 is stored in the memory unit 31 in step 3013, and the process returns to step 3001 so as to be kept standby until establishment of the line connection.

The aforementioned operation makes it possible to realize the mechanisms that:
the rating data 300 accumulated in the mobile terminal 1 are transmitted to the server 2 at timing when the server 2 is connected to the line, or when the mobile terminal 1 passes the ticket gate;
the digest 51 is generated while the line is not connected; and
the digest 51 having the data length corresponding to the time within the passage time from entrance to exit of the ticket gate at the line connection timing is transmitted to the mobile terminal 1.

As the system is designed to transmit a user's preference accumulated in the mobile terminal 1 to the server at the timing when the server is connected to the line, the server 2 is allowed to receive, update, and accumulate a user's preference data appropriately. As the digest may be generated while the line is not connected, the digest may be generated before a user sends the digest transmission request. The digest with the data capacity corresponding to the time within the passage time from the entrance to exit of the ticket gate may be transmitted to the mobile terminal at the timing of establishment of the line connection or the passage through the ticket gate.

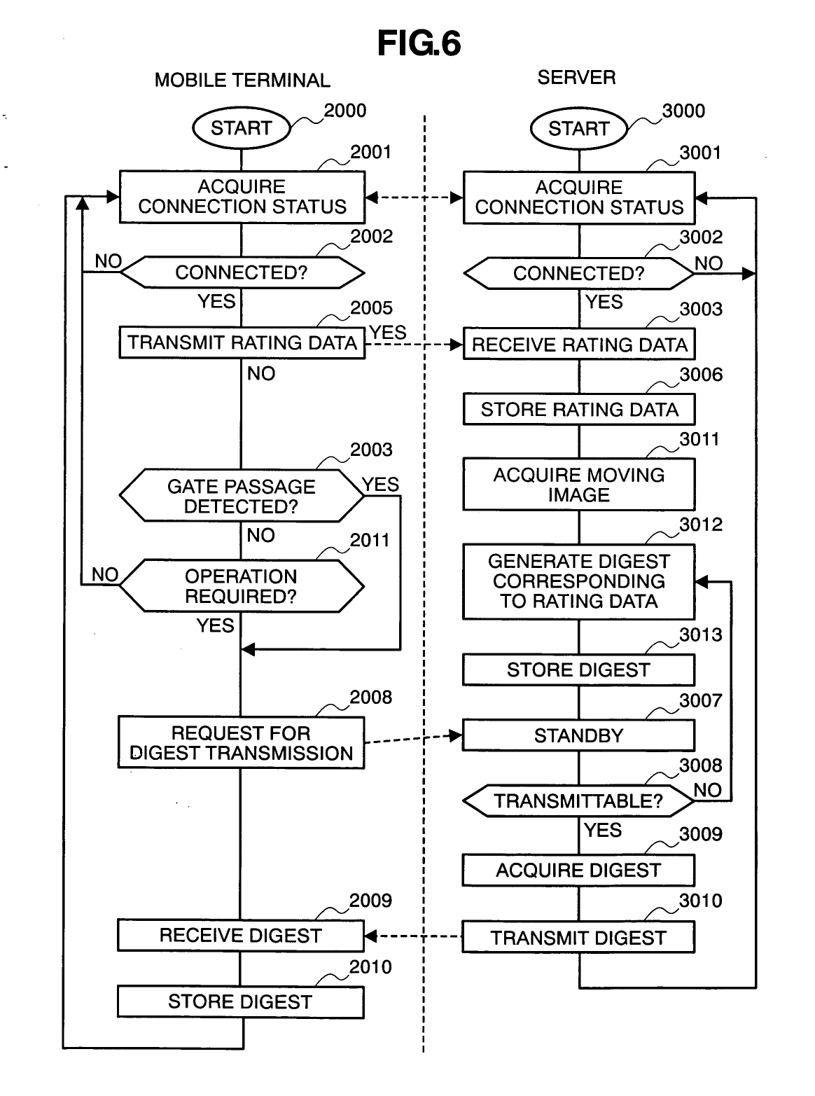

Another operation of the system according to the invention will be described referring to the flowchart shown in FIG. 6.

In the operation according to the flowchart shown in FIG. 6, the digest is transmitted and received in the case where the rating data 300 are transmitted and received, and the passage of the mobile terminal 1 through the ticket gate is determined through a user's operation or the position detector 111.

First in step 2001, the communication line connection status is acquired by the mobile terminal 1. Then in step 2002, it is determined whether the server is connected to the line. In the flowchart, the server 2 is connected to the line upon user's operation of the mobile terminal 1 for the purpose of transmitting the mail, browsing the worldwide web and the like with the communication function of the mobile terminal 1. The rating data 300 may be transmitted at a predetermined interval, for example, 60 minutes using the timer (not shown). It is to be noted that the predetermined interval may be arbitrarily changed.

If it is determined that the connection has been established instep 2002, the process proceeds to step 2005 where the keyword 301 and the rated value 302 among the rating data 300 stored in the rating data retention unit are transmitted. Upon the use of the application with the communication function in the mobile terminal 1, the rating data 300 stored in the memory unit 30 may be transmitted to the server 2.

When the server 2 receives the rating data 300 in step 3003, generation of the digest 51 starts based on the moving image 50 and the rating data 300 stored in the memory unit 31 in steps 3011 and 3012, respectively. The generated digest is stored in the memory unit 31 in step 3013.

It is determined whether the mobile terminal 1 has passed the ticket gate in step 2003. If it is determined that it has not passed the ticket gate, the process proceeds to step 2011 where it is determined whether the operation for requiring the transmission of the digest has been made by a user. If the passage through the ticket gate has been detected by the position detector 111, or the request for transmission of the digest is made through a user's operation, the line is connected again. The signal requiring the transmission of the digest, that is, the digest transmission request is transmitted to the server 2 from the mobile terminal 1 in step 2008. If the passage of the gate is not detected, and the operation for requiring the digest transmission is not made by a user, the process returns to step 2001.

The server 2 is kept standby until the receipt of the transmission request in step 3007, and the process proceeds to step 3008 where it is determined whether it is possible to transmit the digest 51. If the digest 51 has not been generated, it may be determined that it is unable to transmit the digest. If it is determined that the digest transmission is allowed, the digest 51 is transmitted to the mobile terminal 1. If the digest transmission is possible, the server 2 acquires the digest 51 retained in the memory unit 31 in step 3009 so as to be transmitted to the mobile terminal 1 in 3010.

In step 2009, the mobile terminal 1 receives the digest 51 transmitted in step 3010, stores the digest 51 in the memory unit 30 in step 2010, and returns to step 2001 where the process is kept standby until establishment of the line connection.

In the exemplary operation as described above, the mobile terminal 1 transmits the rating data 300 to the server 2, based on which the digest 51 is generated. When a user of the mobile terminal 1 passes the ticket gate or issues the request for digest transmission, the digest 51 that has been already generated may be received. The time period from sending of the transmission request to the receipt of the digest 51 may be reduced. Especially when commuting with the traffic like bus and the train, the digest may be transmitted to the mobile terminal of a user with no need of specific operation for the purpose of the digest transmission request, resulting in improved convenience.

In the embodiment, generation of the digest starts in response to the transmission of the rating data. This allows a user to get the digest within the shorter period from the start of the operation for receiving the digest compared with the case where the generation of the digest starts in response to the request of the digest transmission. In the case where a user enters the place that allows the view of the digest with higher possibility, a user is capable of viewing the digest earlier. When a user desires to view the digest, or there is a high possibility for a user to view the digest, such information may be transmitted and received. This makes it possible to reduce the chance of unnecessary storage or transmission of the digest that won't be viewed by a user. As a result, the load applied to the memory unit of the mobile terminal, and the load to the communication infrastructure may be reduced. The embodiment may be effective for the AV system conforming to a user's preference where the digest conforming to a user's preference is generated so as to be browsed on the mobile terminal.

The invention is not limited to the embodiment as described above, and it is to be understood that it may be modified into various forms so long as it is within the scope of the invention. In the invention, various units used herein are physically realized. However, functions of the respective devices may be realized by the software. A single function of the device may be realized by a plurality of devices. Conversely, functions of a plurality of devices may be realized by a single device.

The invention is effective for the data transmitting and receiving system for transmitting and receiving the digest that summarizes the moving images and the like.

The invention makes it possible to provide the mobile terminal that allows a user to browse the digest easily, the data processing unit for transmitting the digest, and the data transmitting and receiving system.

What is claimed is:

1. A data reception method of receiving a digest that summarizes information data by a mobile terminal, comprising the steps of:
acquiring related information with respect to a user;
retaining the related information that has been acquired;
transmitting the retained related information;
detecting a position of the mobile terminal;
transmitting a transmission request signal that requires a transmission of the digest if the detected position satisfies a predetermined condition; and
receiving the digest based on the related information.

2. The data reception method according to claim 1, wherein the related information and the transmission request signal are transmitted to a data processor that transmits the digest information.

3. The data reception method according to claim 2, wherein the related information comprises preference data information indicating a user's preference.

4. The data reception method according to claim 3, wherein the step of detecting the position of the mobile terminal includes a detection of a passage of the mobile terminal through a first point, and the predetermined condition comprises the passage of the mobile terminal through the first point.

5. The data reception method according to claim 4, wherein the first point comprises one of a ticket gate and a gate.

6. A data transmission method of a digest that summarizes information data from a data processor, comprising the steps of:
storing the information data;
receiving related information with respect to a user;
generating the digest that summarizes the stored information data upon receipt of the related information based thereon;
retaining the generated digest;
receiving a transmission request signal that requires a transmission of the digest; and
transmitting the retained digest upon receipt of the transmission request signal.

7. The data transmission method according to claim 6, wherein the digest is transmitted to the mobile terminal.

8. The data transmission method according to claim 7, wherein the related information to be received is assigned with information indicating a time length, and a time length for replaying the digest is generated conforming to the information indicating the time length.

9. The data transmission method according to claim 6, wherein the related information comprises preference data information indicating a user's preference.

10. A mobile terminal capable of receiving a digest that summarizes information data, comprising:
an acquiring unit that acquires related information with respect to a user;
a retention unit that retains the related information acquired by the acquiring unit;
a first transmitter that transmits the related information;
a position detector that detects a position of the mobile terminal;
a second transmitter that transmits a transmission request signal when the position detected by the position detection unit satisfies a predetermined condition; and
a receiver that receives the digest that relates to the related information.

11. The mobile terminal according to claim 10, wherein the first transmitter transmits the related information to a data processing terminal;
the second transmitter transmits the transmission request signal to the data processing terminal; and
the receiver receives the digest from the data processing terminal.

12. The mobile terminal according to claim 10, wherein the related information comprises preference data information indicating a user's preference.

13. The mobile terminal according to claim 10, wherein the position detector detects a passage of the mobile terminal through a first point, and the predetermined condition comprises the passage of the mobile terminal through the first point.

14. The mobile terminal according to claim 13, wherein the first point comprises one of a ticket gate and a gate.

15. The mobile terminal according to claim 14, further comprising a third transmitter that transmits a time information indicating a passage time taken from a passage through one of the ticket gate and the gate to a subsequent passage through one of the ticket gate and the gate to a data processor.

16. A data processing system that transmits a digest that summarizes information data, comprising:
a memory that stores the information data;
a first receiver that receives related information with respect to a user;
a data generator that generates the digest that summarizes the information data that has been stored in the memory upon receipt of the related information based thereon;
a data retention unit that retains the generated digest;
a second receiver that receives a transmission request signal that requires a transmission of the digest; and
a transmitter that transmits the retained digest upon receipt of the transmission request signal.

17. The data processing system according to claim 16, wherein:
the first receiver receives the related information from the mobile terminal;
the second receiver receives the transmission request signal from the mobile terminal; and
the transmitter transmits the digest to the mobile terminal.

18. The data processing system according to claim 17, wherein the related information comprises preference data information indicating a user's preference.

19. The data processing system according to claim 18, further comprising a third receiver that receives information indicating a time length, wherein the data generation unit generates the digest with a time length for replaying the digest conforming to the information indicating the time length received by the third receiver.

20. A data transmitting and receiving system that transmits a digest that summarizes information data from a data processor to a mobile terminal, wherein:
the mobile terminal including:
an acquiring unit that acquires related information with respect to a user;
a retention unit that retains the related information acquired by the acquiring unit;
a first transmitter that transmits the related information to the data processor;
a position detector that detects a position of the mobile terminal;
a second transmitter that transmits a transmission request signal to the data processor if the position detected by the position detector satisfies a predetermined condition; and
a digest receiver that receives the digest related to the related information transmitted from the data processor; and the data processor including:
a memory that stores the information data;
a first receiver that receives the related information from the mobile terminal;
a data generator that generates the digest that summarizes the information data that has been stored in the memory upon receipt of the related information based thereon;
a digest data retention unit that retains the generated digest;
a second receiver that receives the transmission request signal that requires a transmission of the digest; and
a digest transmitter that transmits the retained digest upon receipt of the transmission request signal.

21. The data transmitting and receiving system according to claim 20, wherein the related information comprises preference data information indicating a user's preference.

22. The data transmitting and receiving system according to claim 20, wherein:
the mobile terminal includes a position detector that detects a position of the mobile terminal; and
the digest transmitter transmits the transmission request signal to the data processor when the position detected by the position detector satisfies a predetermined condition.

23. The data transmitting and receiving system according to claim 22, wherein:
the position detector comprises a gate passage detector that detects a passage of the mobile terminal through a first point; and
the condition includes the passage of the mobile terminal passes through the first point.

24. The data transmitting and receiving system according to claim 23, wherein the first point comprises one of a ticket gate and a gate.

25. The data transmitting and receiving system according to claim 24, wherein:
the mobile terminal includes a third transmitter that transmits a time information indicating a passage time taken from a passage through one of the ticket gate and the gate to a subsequent passage through one of the ticket gate and the gate;
the data processor includes a third receiver that receives the time information; and
the digest generator generates the digest with a time length for replaying the digest conforming to a time length indicated by the information received by the third receiver.
